(19) United States
(12) Patent Application Publication
(10) Pub. No.: US 2026/0170856 A1
(43) Pub. Date: Jun. 18, 2026

(54) DETECTION OF INTERACTING CELLULAR BODIES

(71) Applicant: Lumicks CA Holding B.V., Amsterdam (NL)

(72) Inventors: Jelle Van Der Horst, Amsterdam (NL); Willem Mathijs Rozemuller, Amsterdam (NL)

(21) Appl. No.: 18/707,834

(22) PCT Filed: Nov. 9, 2022
(86) PCT No.: PCT/NL2022/050632

§ 371 Date: May 6, 2024

(30) Foreign Application Priority Data
Nov. 9, 2021 (NL) 2029685

(51) Int. Cl. G06V 20/69; G06T 7/00; G06T 7/13

(52) U.S. Cl. CPC G06V 20/695; G06T 7/0012; G06T 7/13; G06V 20/698; G06T 2207/30024

(57) ABSTRACT

Methods and systems for selecting cellular bodies are disclosed. The method comprises determining or receiving first and second images of first and second cellular bodies in a holding space. The first and second images are obtained with first and second imaging modalities. Each pixel in the first image may be associated with a pixel in the second image. A set of first pixels representing first cellular bodies in the first image, and groups of second pixels representing the second cellular bodies in the second image are detected. For each second cellular body, an interaction parameter is determined between the respective second cellular body and one or more of the first cellular bodies. The parameter may represent a contact surface between the respective second cellular body and the first cellular bodies. Groups of second pixels are selected for which the determined parameter is greater than or smaller than a threshold.

### CROSS-REFERENCE TO RELATED APPLICATION(S)

This Application is a Section 371 National Stage Application of International Application No. PCT/NL2022/050632, filed Nov. 9, 2022 and published as WO 2023/085925 A1 on May 19, 2023, in English.

### FIELD OF THE INVENTION

The invention relates to selecting cellular bodies in an image; and, in particular, though not exclusively, to methods and systems for selecting cellular bodies in an image and a computer program product enabling a computer system to perform such methods.

### BACKGROUND OF THE INVENTION

The study of cell interactions, e.g. the binding strength between two cells or between cells and biomolecules, is a highly relevant and active research area in the biosciences. For example, the avidity characterizes the cumulative effect of multiple individual binding interactions between cells. Similarly, the affinity characterizes the strength with which one molecule binds to another molecule, e.g. the strength with which a receptor on the cell membrane of an immune cell binds to an antigen on the target cell. The avidity and affinity are examples of parameters that play an essential role in the study and development of therapies in medicine, e.g. immune oncology and immunology in general.

A known technique for studying cell adhesion to biomolecules and for studying interaction strengths between cells is referred to as acoustic force spectroscopy, AFS, wherein interactions between cells and a functionalized surface can be studied by applying an acoustic force to the cells. For example, Kamsma et al. in their article ‘Single-cell acoustic force spectroscopy: resolving kinetics and strength of T cell adhesion to fibronectin’, 2018, Cell Reports 24, 3008-3016, Sep. 11, 2018 study the adhesion of T cells to fibronectin using an acoustic force spectroscopy AFS system.

Similarly, WO2018/083193 describes an AFS system including a microfluidic cell comprising a so-called functionalized wall surface which may include target cells. A plurality of unlabelled effector cells, e.g. T-cells, can be flushed into the microfluidic cell, so that they can settle and bind to target cells. Thereafter, an acoustic source is used to exert a ramping force on the bound effector cells so that effector cells will detach from the target cells at a certain force. During this process, the spatiotemporal behavior of the effector cells in the microfluidic cell is imaged using an imaging microscope. The interaction between cells, e.g. the force at which the effector cells detach, may be determined by analysing the captured video images. For example, the cell avidity between the effector cells and the target cells can be determined this way.

In these AFS systems, the imaging microscope may have a focal plane essentially parallel to the functionalized wall surface so that camera acquired images will typically show effector cells in the ‘foreground’ against a ‘background’ representing the functionalized wall surface that comprise the target cells. The analysis of these captured images may include detecting cells and tracking detected cells in two or three dimensions. During a typical AFS experiment, a large amount of effector cells needs to be detected, accurately localized and tracked during the settling of the cells onto the functionalized wall surface, the binding of the effector cells to target cells (incubation) and/or the detachment of the effector cells from the target cells. However, automatic detection and tracking of a multitude, e.g. hundreds or even thousands of cells against a background of a highly dynamic, “living” functionalized wall surface, comprising for example a monolayer of (similar or different) cells, is not a trivial problem.

WO 2021/089654 A1 describes such an automated force spectroscopy method, which method comprises determining interaction between first cells and second cells in a holding space, the holding space including a functionalized wall comprising the second cells. The described method comprises detecting and tracking groups of pixels representing first cells in bright-field images. If the groups of pixels become indistinguishable from the background, which includes the functionalized wall surface comprising the second cells, the first cells are assumed to have settled on the functionalized wall surface and are assumed to interact with the second cells. When a force is applied and the first cells become distinguishable again from the background, a detachment event is detected. Background images may be acquired before and/or after the presence of the first cells in the holding space, to aid in the detection of the first cells.

However, the functionalized wall surface is typically not completely covered with cells, but also comprises ‘empty’ patches without cells, e.g., patches of (possibly primed) glass. The first cells may interact with such empty patches in a different way than with the cells on the functionalized wall surface. In order for the system to determine an interaction, such as the avidity, between the first and second cells as accurately as possible, it may be important that only cells that are attached to a functionalized area of the wall should be taken into account in the analysis.

Hence, from the above, it follows that there is a need in the art for an accurate and robust automated method for determining interactions between a first cellular body on a functionalized area of a wall surface and a second cellular body.

### SUMMARY OF THE INVENTION

In a first aspect, the invention may relate to a method for selecting cellular bodies. The method comprises determining or receiving one or more first images and one or more second images. The one or more first images and the one or more second images may be images of first cellular bodies, e.g. target cells, interacting with second cellular bodies, e.g. effector cells, in a holding space. The holding space may include a functionalized wall surface comprising the first cellular bodies. The one or more first images represent at least the first cellular bodies, and the one or more second images represent at least the second cellular bodies. The first image is obtained with a first imaging modality, preferably bright-field imaging, and the one or more second images are obtained with a second imaging modality, preferably fluorescence imaging. At least one of the first and second imaging modalities may provide images on which the first respectively second cellular bodies can be uniquely determined. Each pixel in each of the one or more first images may be associated with a pixel in each of the one or more second images. The method further comprises detecting a set of first pixels representing first cellular bodies in the first image, and detecting groups of second pixels representing the second cellular bodies in the one or more second images. The method further comprises determining, for each second cellular body represented by a respective group of second pixels, an interaction parameter between respective second cellular body and one or more of the first cellular bodies based on the detected first and second pixels. The interaction parameter may represent a contact surface between the respective second cellular body and the one or more first cellular bodies. The method may further comprise selecting groups of second pixels for which the determined interaction parameter is greater than or smaller than an interaction threshold.

In a typical cell interaction experiment, images are acquired using brightfield microscopy, often in the form of movies. Brightfield microscopy is a relatively simple microscopy technique that requires little sample preparation and can be performed with a relatively simple and economical set-up. The one or more first images can be a frame from such a movie, for example. Typically, these first images show both the first cellular bodies and the second cellular bodies. A drawback of brightfield imaging is that the first cellular bodies on the functionalized wall surface can be hard to distinguish from the second cellular bodies. This is particularly true when automated image-processing is used to analyze the images.

The inventors have recognized that the first and/or second cellular bodies can be identified (i.e., distinguished from the other cellular bodies and from the background) by using a second imaging modality that either shows only the first, respectively second cellular bodies, or images the first and/or second cellular bodies in such a way that they may be distinguished from the second cellular bodies, preferably in an easy and robust manner using an automated image processing system. A typical example is fluorescence imaging in combination with fluorescently labelled second cellular bodies.

By using a (typically different) imaging modality to detect only the second cellular bodies, the second cellular bodies may be detected at the time of their interaction with the first cellular bodies. Earlier techniques would, for example, determine a background image prior to flushing in the second cellular bodies, and assume that the non-functionalized wall surface parts before the flushing-in of the second cellular bodies are at the same locations as after the flushing-in, during the interaction. However, the functionalized wall surface typically comprises living cells (or other living cellular bodies) which may move around in the time interval between acquisition of the background image and the interaction image. Moreover, the flushing in is a relatively violent procedure, which may disturb the distribution of the second cellular bodies, increasing the probability that the functionalized and non-functionalized parts of the functionalized wall surface have changed.

As used herein, a functionalized wall surface refers to a wall surface which is at least partially functionalized. The functionalized wall typically comprises a transparent substrate, e.g., a glass substrate. The substrate may be primed using a priming layer which improves the binding of second cellular bodies to the wall surface. The second cellular bodies preferably form a monolayer, i.e., a layer of (generally) at most one cell thick. The wall surface may also comprise areas that are not covered with second cellular bodies. These areas may be bare or may be primed with the priming layer (also known as a coating or coating matrix). In this disclosure, the term ‘empty patch’ is used for any area of the at least partially functionalized wall surface that is not covered with second cellular bodies. Although in the examples in this disclosure, the first cellular bodies are frequently target cells and the second cellular bodies are frequently effector cells, it should be noted that their roles can be reversed, and more in general, the first and second cellular bodies can be of any type. Below, other examples of first and second cellular bodies will be provided.

Additionally, earlier methods might identify second cellular bodies by subtracting a background image acquired prior to the flushing in of the second cellular bodies. However, this method only gives satisfactory results if the second cellular bodies have sufficient contrast relative to the first cellular bodies. Often, however, first and second cellular bodies are very hard to distinguish reliably using automated image analysis.

In the embodiments described herein, identifying the first and second cellular bodies may be achieved by using a first imaging modality that images the first cellular bodies in a way that they can be easily distinguished from the second cellular bodies; or conversely, by using a second imaging modality that images the second cellular bodies in a way that they can be easily distinguished from the first cellular bodies. In a typical embodiment, the second imaging modality only images the second cellular bodies and does not image the first cellular bodies. To that end, the second cellular bodies may comprise an imaging marker, e.g., a fluorescent marker. An example of an imaging modality that may be used as the second imaging modality is fluorescence imaging. The second imaging modality could also be any other imaging modality which yields specific contrast for the second cellular bodies; e.g., one could use Raman imaging if one can identify a Raman line specific for the second cellular bodies or if one would label the second cellular bodies to generate a specific Raman contrast. The first imaging modality may be used to image at least the first cellular bodies. In other embodiments, the first and second imaging modalities may be the same imaging modality, which may distinguish between empty patches, first cellular bodies, and second cellular bodies, for instance multi-color imaging. Multi-color imaging may comprise multi-color fluorescence imaging, where the first and second cellular bodies have been labelled with different fluorescent markers, or multi-color bright-field imaging, where the first and/or second cellular bodies have been stained with one or more suitable dyes. Other methods to distinguish first and/or second cellular bodies in a sample with first and second cellular bodies based on two or more imaging modalities may be apparent to the skilled person.

The detection of the set of first pixels may be based on, for example, one or more of the following classifiers: decision tree, random forest, support vector machine, Naïve Bayes, k-nearest neighbors, or an artificial neural network. The classifier may use, for example, one or more of the following features: Gaussian blurring, Gaussian gradient, structure tensor, Hessian eigenvalues, features using the intensity profile of each pixel along the vertical-direction, computational phase-contrast. Other methods may be apparent to the skilled person.

The detection of the groups of second pixels may comprise selecting pixels that are valued such that they distinguish from the background in the one or more second images. In an example, a detected pixel groups consist of pixels having a relatively high intensity with respect to other pixels in the image or in a neighborhood of the pixel group.

In an embodiment, detecting the set of first pixels representing first cellular bodies comprises detecting first pixels in the one or more first images representing either first cellular bodies or second cellular bodies, and selecting, from the detected first pixels, the set of first pixels representing first cellular bodies, preferably by removing from the detected first pixels the first pixels that are associated with second pixels representing second cellular bodies. In another embodiment, detecting the groups of second pixels representing second cellular bodies comprises detecting second pixels in the one or more second images representing either first cellular bodies or second cellular bodies, and selecting, from the detected second pixels, the groups of second pixels representing second cellular bodies, preferably by removing from the detected second pixels the second pixels that are associated with first pixels representing first cellular bodies

Thus, if the first imaging modality represents both the first and the second cellular bodies, and the second imaging modality represents only the second cellular bodies, the first cellular bodies may be identified by removing second cellular bodies as determined based on the second imaging modality from the aggregate of first and second cellular bodies as determined based on the first imaging modality. Alternatively, if the second imaging modality represents both the first and the second cellular bodies, and the first imaging modality represents only the first cellular bodies, the second cellular bodies may be identified by removing first cellular bodies as determined based on the first imaging modality from the aggregate of first and second cellular bodies as determined based on the second imaging modality. That way, both the first and the second cellular bodies may be distinguished, while only one of either the first or second cellular bodies may need to be uniquely identifiable. Thus, it can be sufficient to mark or label only the first or second cellular bodies.

Although such a step may also remove parts of the first (respectively second) cellular bodies that are covered by the second (respectively first) cellular bodies, it is sufficient for the determination of an interaction surface between first and second cellular bodies that a part of the first and second cellular bodies remains visible.

As used herein, pixels in a first image are associated with pixels in a second image if they correspond to the same physical location in the holding space. The first image and the one or more second images can be obtained by a single camera on a single set of pixels (e.g. by interlacing the image acquisition modalities). In that case, associated pixels refer to the same camera pixel. If different cameras are used (or if different pixel sets of the same camera are used), image registration may be used to map the first image on the one or more second images or the one or more second images on the first image. The associated pixels may then refer to pixels in the mapped first or second image(s). As used herein, ‘pixel’ may refer to a two-dimensional or three-dimensional (3D) picture element (the latter of which is also sometimes known as a voxel). E.g., voxels may be used if 3D images (possibly comprising stacks of 2D images) are used for the determination of interaction parameters. In some embodiments, the one or more first images may be combined into a single first 3D image, and/or the one or more second images may be combined into a single second 3D image.

The one or more first images typically allow determination of areas that are covered by either first cellular bodies or second cellular bodies; and, thus, also of areas that are not so covered, i.e., ‘empty’ patches. In other embodiments, the empty patches may be determined based on the one or more second images, or based on a combination of one or more first and one or more second images.

In an embodiment, the method, in particular the step of determining an interaction parameter, may further comprise determining a border region for the group of second pixels. The border region may represent an edge of the second cellular body represented by the group of second pixels. In such an embodiment, the interaction parameter may be determined based on properties of the border region, for example based on an amount of overlap between the border region and the set of first pixels representing one or more first cellular bodies. For example, determining the interaction parameter may comprise determining an absolute and/or relative amount of pixels in the border region that are associated with pixels in the set of first pixels. This way, an interaction parameter may be determined also if only either the first or the second cellular bodies may be reliably identified, and where the second respectively first cellular bodies are detected by subtracting the first respectively second cellular bodies from an aggregate of first and second cellular bodies. This is, for example, the case in typical brightfield microscopy images. In cases where the first and second cellular bodies can each be reliably and separately identified, it can still be beneficial to determine a border region around the second cellular bodies to detect first and second cellular bodies that do touch but do not overlap.

In an embodiment, determining an interaction parameter for a group of second pixels comprises assigning a weight to pixels in the border region, preferably the weight being based on a distance between the pixel and the nearest pixel in the group of second pixels, more preferably the weight decreasing if the distance increases. The closer to a group of second pixels an overlap is determined, the higher the probability that this overlap is indicative of an interaction between first and second cellular bodies. In other embodiments, the weight may be based on a distance to the nearest pixel in the set of first pixels.

In an embodiment, determining an interaction parameter for a group of second pixels comprises comparing a local curvature of the group of second pixels with the local curvature of the set of first pixels. If the local curvatures of two cellular bodies that are located closely together match, e.g., if a convex part of one cellular body appears to be associated with a concave part of another cellular body, it is highly likely that these cellular bodies are in contact with each other.

In some embodiments, the first imaging modality may be selected to image only the first cellular bodies and the second imaging modality may be selected to image only the second cellular bodies. For example, the first imaging modality can be fluorescence imaging with a different color than the second imaging modality, where the first and second cellular bodies are respectively labelled with suitably chosen fluorescent labels. In such an embodiment, the overlap between the first and second cellular bodies can be determined by identifying regions where both first cells and second cells are detected, provided that the cellular bodies are transparent to the imaging. Nevertheless, as was just mentioned, it may still be beneficial to determine a border region around the second cellular bodies to detect also second cellular bodies that touch but do not overlap first cellular bodies. A further advantage of such imaging methods is that it can also be used to detect second cells that are completely covered by first cellular bodies; however, in practice this situation is relatively rare.

An advantage of using bright-field imaging to detect the first (and second) cellular bodies is that it does not require marking the first cellular bodies with a fluorescent marker. This results in an easier and more economic workflow. Moreover, by not using a marker the risk of affecting the cells in other ways is reduced, resulting in an increased reliability of the results as applied to unmarked cells as are typically present in a living body. Additionally, the first cellular bodies are typically used for a number of consecutive experiments, e.g., five to ten. Hence, these cellular bodies may be exposed to a larger amount of excitation light and illumination light than the second cellular bodies, but they should also remain stable (and alive) longer than the second cellular bodies. Hence, it is often preferable to label the second cellular bodies rather than the first cellular bodies.

In an embodiment, determining a border region of a group of second pixels comprises selecting pixels not belonging to the group of second pixels that have a distance to a pixel in the group of second pixels that is equal to or less than a predetermined or interactively determined amount. This way, a border region around the perimeter of the group of second pixels may be selected. The distance may be provided in, e.g., pixels or in micrometers. The distance may be provided in absolute or relative terms, e.g., relative to a size of the second cellular body. The distance may be fixed or may depend on properties of the first and/or second cellular bodies, such as size, shape, or type.

In an embodiment, an image filter may be determined based on the selected groups of second pixels. The image filter can be, e.g., an image mask masking parts of the one or more first and/or second images not representing second cellular bodies for which the interaction parameter meets a certain criterion. The image filter may also (alternatively) comprise a list of regions of interest defining image areas representing second cellular bodies for which the interaction parameter meets the criterion This way, further image processing and/or data processing may be limited to groups of pixels representing second cellular bodies with a sufficiently large interaction area with first cellular bodies, as the determined interaction parameter may be used as an estimate for the interaction area between the first and second cellular bodies. Thus, events occurring on empty patches (sometimes referred to as non-functional areas) may be excluded, as well as events associated with only barely interacting cells or where interaction cannot be established with sufficient certainty. The use of an image filter may also increase the efficiency of further image processing steps, as only the filtered part of the image needs to be evaluated.

In an embodiment, the interaction threshold is a predetermined threshold. In a different embodiment, the interaction threshold is determined interactively based on input received from a user. A predetermined value for the interaction threshold may depend on the expected interaction strength between the first and second cellular bodies, the types of cellular bodies, patterns in interaction (e.g., avidity) measurements, et cetera. By allowing a user to determine the interaction threshold interactively, a user may obtain information about appropriate thresholds, or e.g. adjust the parameter based on experimental requirements. A very high threshold value may be associated with a high probability of a large interaction surface, but may reduce the number of useful measurements in a single experiment. Further, the interaction threshold may vary, for example, in dependence of one or more system parameters, such as in dependence of an applied force to the first cellular bodies or any other parameter. In some cases, a plurality of thresholds may be used to determine a plurality of categories for different values or ranges of values of the interaction parameter, possibly including a category for which the interaction parameter is zero (e.g., second cellular bodies for which there is no detected overlap with first cellular bodies). That way, cell interaction properties such as cell avidity may be determined based on the value of the interaction parameter (e.g., the amount of overlap) and, optionally, compared to the situation wherein there is no overlap and therefore, presumably, no interaction between the first and second cellular bodies.

In an embodiment, the interaction threshold depends on a type, size and/or shape of first cellular bodies and/or of the second cellular bodies. For example, certain types of effector cells may be expected to interact more strongly with certain target cells than others, so that a smaller overlap region may be deemed sufficient for a reliable measurement. Irregularly shaped cells may feature different behavior for the extensions (e.g. filopodia, lamellipodia, axons, dendrites, etc.) and the central body. Thus, the interaction threshold may be based on a distance to a center of cellular body or to a distance to one of the extensions.

In an embodiment, the method may further comprise determining a detachment event. A detachment event may define a second cellular body being detached from a first cellular body due to application of a force on the second cellular body. The method may further comprise determining information about the interaction between the first cellular body and the second cellular body based on the force applied to the second cellular body at the moment of the detachment event and, optionally, the interaction parameter. Thus, the interaction strength may be determined in a robust and reliable manner. Additionally, a relationship between interaction area and interaction strength might be determined based on the interaction parameter and the force for which a detachment event occurs.

In such an embodiment, a sequence of images may depict the spatiotemporal response of the one or more second cellular bodies while a force is applied to them. In an example, such force may be ramped up, in order to determine the amount of second cellular bodies that are detached from the first cellular bodies as a function of the applied force. Such force may be applied to the one or more second cellular bodies using, for example, a centrifuge system, a shear-flow system and/or an acoustic wave generator.

The term cellular body used in this application (as applied to the first and/or second cellular bodies) may include cell portions like subcellular organelles, cell nuclei, and/or mitochondria. A cellular body may be unicellular or pluricellular, such as small clumped cell groups, plant or animal biopsies, dividing cells, budding yeast cells, colonial protists, etc. A cellular body may also be an animal embryo in an early stage of development (e.g. the morula-stadium of a mammal, possibly a human embryo). In particular cases different types of cellular bodies may be studied together. E.g., cellular bodies from a mucosal swab, blood sample, or other probing techniques could be used as first and/or second cellular bodies (i.e. either first or second cellular bodies or both may comprise a mix of different types of cellular bodies). A cellular body may also be one or more immune cells, one or more tumor cells, one or more cells that have been infected, for example by a virus.

Some typical non-limiting examples of first cellular bodies comprise tumor cells, stem cells, epithelial cells, B16 melanoma, fibroblasts, endothelial cells, HEK293, Hela, 3T3, MEFs, HuVECs, microglia, and neuronal cells. The one or more first cellular bodies may be attached to the functionalized wall surface using a primer, which may comprise one or more types of interaction moieties.

In a typical example, the second cellular bodies may include at least one of: lymphocytes, monocytic cells, granulocytes, T cells, natural killer cells, B-Cells, CAR-T cells, dendritic cells, Jurkat cells, bacterial cells, red blood cells, macrophages, TCR Tg T-cells, OT-I/OT-II cells, splenocytes, thymocytes, BM derived hematopoietic stem cells, TILs, tissue derived macrophages, innate lymphoid cells. In other examples, the roles of these cellular bodies may be reversed.

An image as used herein may be understood to comprise a plurality of pixels that may be arranged in a raster to form the image. A pixel may be understood to be characterized by its position in the image. Further, when reference is made to a pixel in one image and the same pixel in a different image, then this may be understood to refer to the two pixels having substantially the same position within their respective images, thus the position of the pixel within said one image being substantially the same as the position of the “same pixel” in the different image. Pixels that are the same typically represent the same location in the physical world, e.g., the same part of the holding space. Further, pixels groups and regions of interest may be understood to consist of pixels. Likewise, reference may be made to a pixel group or region of interest in one image and the same pixel group or the same region of interest in another image. This may be then understood in that two pixel groups or two regions of interest are meant each having substantially the same position in their respective image, thus one pixel group or region of interest having a certain position within said one image and the other pixel group or region of interest having the same certain position within the other image.

For a particular cellular body represented by a plurality of pixel groups in respective images, its movement may be understood to be represented by the different position that the pixel groups have within their respective images.

One aspect of this disclosure relates to a data processing system comprising a computer readable storage medium having computer readable program code embodied therewith, and a processor, preferably a microprocessor, coupled to the computer readable storage medium, wherein responsive to executing the computer readable program code, the processor is configured to perform any of the methods described herein.

One aspect of this disclosure relates to a computer program or suite of computer programs comprising at least one software code portion or a computer program product storing at least one software code portion, the software code portion, when run on a computer system, being configured for executing any of the methods described herein.

One aspect of this disclosure relates to a system for determining interaction between first cellular bodies, e.g., target cells, and second cellular bodies, e.g., effector cells, the system comprising a sample holder comprising a holding space the holding space being configured to have a functionalized wall surface comprising the first cellular bodies, the fluid medium comprising the one or more second cellular bodies, a force generator for providing a force to the second cellular bodies in the holding space, an imaging system for capturing images of the one or more first cellular bodies and the one or more second cellular bodies in the holding space, and a data processing system as described herein.

The data processing system may be configured to control the force generator as well.

One aspect of this disclosure relates to a non-transitory computer-readable storage medium storing at least one software code portion, the software code portion, when executed or processed by a computer, is configured to perform any of the methods described herein.

As will be appreciated by one skilled in the art, aspects of the present invention may be embodied as a system, a method or a computer program product.

Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.0

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java(TM), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

Moreover, a computer program for carrying out the methods described herein, as well as a non-transitory computer readable storage-medium storing the computer program are provided. A computer program may, for example, be downloaded (updated) to the existing data processing systems or be stored upon manufacturing of these systems.

Elements and aspects discussed for or in relation with a particular embodiment may be suitably combined with elements and aspects of other embodiments, unless explicitly stated otherwise. Embodiments of the present invention will be further illustrated with reference to the attached drawings, which schematically will show embodiments according to the invention. It will be understood that the present invention is not in any way restricted to these specific embodiments.

### BRIEF DESCRIPTION OF THE DRAWINGS

FIG. 1 schematically depicts a force spectroscopy system according to an embodiment;

FIGS. 2A and 2B schematically depict cross-sectional views of a sample holder according to an embodiment;

FIG. 3A-3D depict schematics of processes occurring in a holding space according to an embodiment;

FIG. 4 illustrate examples of avidity curves measured using an acoustic force spectroscopy system;

FIG. 5A-H schematically illustrate selection of second cellular bodies interacting with first cellular bodies in the holding space according to an embodiment;

FIG. 6A-E schematically illustrate selection of effector cells interacting with target cells in the holding space according to an embodiment;

FIG. 7 depicts a flow diagram of a method of determining an interaction between first and second cellular bodies according to an embodiment;

FIG. 8 illustrates an embodiment using centrifugal force application; and

FIG. 9 is a block diagram illustrating an exemplary data processing system that may be used for executing methods and software products described in this disclosure.

### DETAILED DESCRIPTION

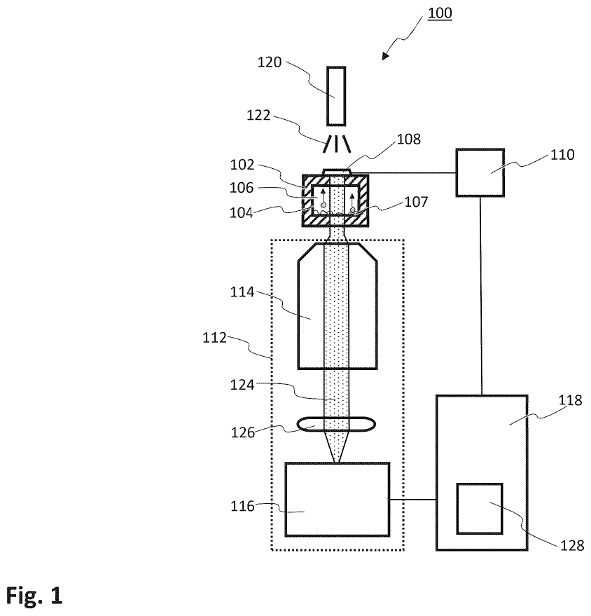

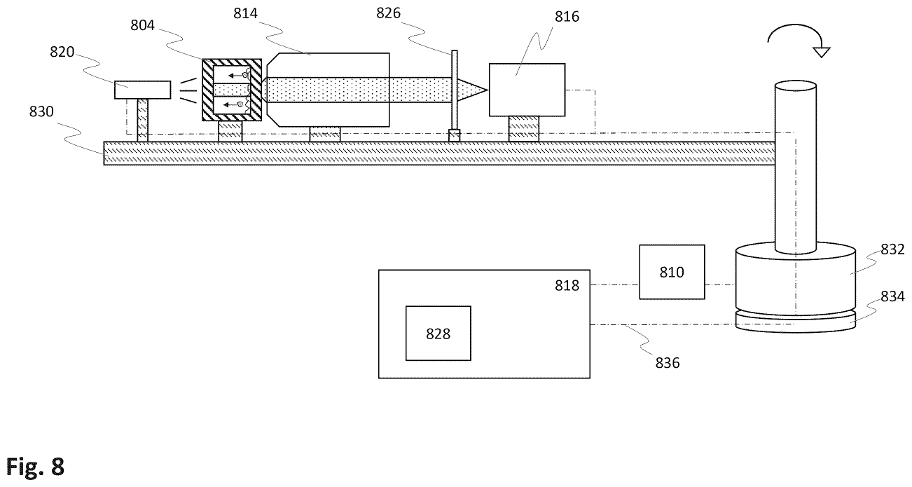

FIG. 1 is a schematic drawing of an embodiment of a force spectroscopy system that can be used with the embodiments described in this application. The depicted force spectroscopy system 100 is an acoustic force spectroscopy (AFS) system, but other force spectroscopy systems may similarly be used, e.g. a centrifugal force spectroscopy system as described below with reference to FIG. 8, or a shear-flow force spectroscopy system.

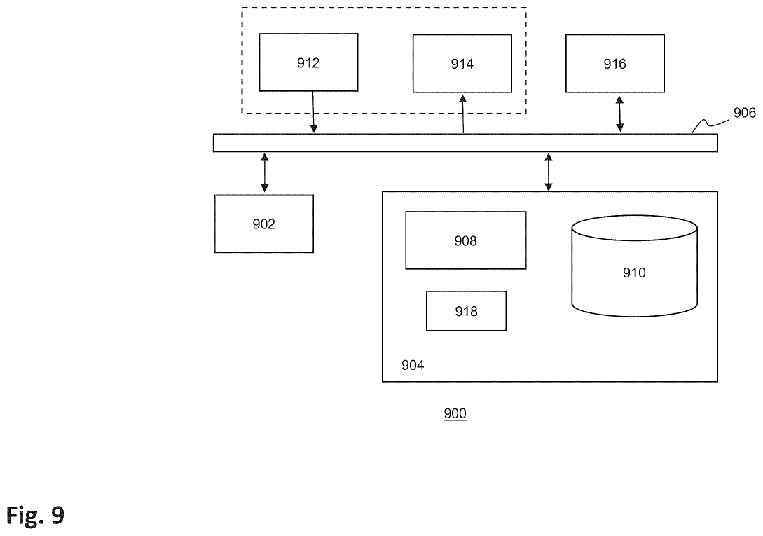

The force spectroscopy system 100 comprises a sample holder 102 comprising a holding space 104 for holding a sample 106. The holding space may comprise a functionalized wall surface 107 comprising first cellular bodies. The holding space may be part of a flow cell (also referred to as a microfluidic cell). The sample typically comprises second cellular bodies in a fluid medium, e.g. a liquid or a gel. The system further comprises a force generator 108 for providing a force to the one or more second cellular bodies in the holding space. The force generator, in an embodiment, may be an acoustic wave generator based on a piezo element, connected to the sample holder for generating a bulk acoustic wave in the holding space so that a force is exerted on at least the second cellular bodies that may be present in the holding space. In a typical embodiment, the force that is applied to the second cellular bodies also affects the first cellular bodies. However, the binding strength between the first cellular bodies and the wall surface is typically much larger than the binding strength between the first cellular bodies and the second cellular bodies (at least for some of the second cellular bodies). The force generator may be connected to a controller 110, which may be integrated in or connected to a data processing system 118, so that the force exerted on the cellular bodies can be controlled. An exemplary data processing system is described below with reference to FIG. 9.

The depicted system further comprises an imaging system configured to capture images of the cellular bodies in the holding space 104. The imaging system may include a microscope 112 including optics, e.g. adjustable objective 114, and a camera 116 for capturing images, e.g. video frames, of the processes in the holding space. The imaging system may be connected to the data processing system 118 that is configured to perform any of methods, in particular the image analyses, as described in this application. The data processing system may also be configured to control any of the elements of the depicted system, such as the controller 110 (and thus the force generator), and one or more, e.g. all, elements of the imaging system, which are further described below.

The imaging system may comprise a light source 120 for illuminating the sample, including the functionalized wall surface described herein, using any suitable optics (not shown) to provide a desired illumination intensity and intensity pattern, e.g. plane wave illumination, Köhler illumination, etc., known per se. Here, the light 122 emitted from the light source may be directed through the force generator 108 to (the sample in) the sample holder 102 and sample light 124 from the sample is transmitted through the objective 114 and through an optional tube lens 126 and/or further optics (not shown) to the camera 116. The objective and the camera may be integrated. In an embodiment, two or more optical detection systems, e.g. with different magnifications, may be used simultaneously for detection of sample light, e.g. using a beam splitter.

The light source 120 may comprise multiple light sources emitting light in different colors for use by the different imaging modalities. For example, the light source may comprise a 630 nm led for exciting a fluorescent dye in the sample (e.g. a CellTrace Deep Red dye in the second cellular bodies). The light source may further comprise a 670 nm LED for bright-field illumination of the sample. A filter (not shown) may be provided in front of the camera 116 to transmit the emitted fluorescent light and the bright-field light, while blocking the excitation light. The data processing system 118, or another controller, may be configured to alternatingly switch between the fluorescence excitation light and the bright-field illumination light, and to simultaneously trigger the camera in synchrony with the light switching. Thereby, fluorescence images may be alternated with bright-field images and may be recorded in an interlaced fashion by a single camera. The data processing system may be configured to de-interlace the images and to separate the images into first and second Images. If multi-color imaging is used (either fluorescent or bright-field multi-color imaging), the first and second images may be the same images.

In another embodiment, not shown but discussed in detail in WO2014/200341, the system 100 may comprise a partially reflective reflector and light emitted from the light source is directed via the reflector through the objective and through the sample, and light from the sample is reflected back into the objective, passing through the partially reflective reflector and directed into a camera via optional intervening optics. Further embodiments may be apparent to the reader.

The sample light 124 may comprise light affected by the sample (e.g. scattered and/or absorbed) and/or light emitted by one or more portions of the sample itself e.g. by chromophores/fluorophores attached to the cellular bodies.

Some optical elements in the imaging system may be at least one of partly reflective, dichroic (having a wavelength specific reflectivity, e.g. having a high reflectivity for one wavelength and high transmissivity for another wavelength), polarization selective and otherwise suitable for the shown setup. Further optical elements e.g. lenses, prisms, polarizers, diaphragms, reflectors etc. may be provided, e.g. to configure the system 100 for specific types of microscopy.

The sample holder 102 may be formed by a single piece of material with a channel inside, e.g. glass, injection molded polymer, etc. (not shown) or by fixing different layers of suitable materials together more or less permanently, e.g. by welding, glass bond, gluing, taping, clamping, etc., such that a holding space 104 is formed in which the fluid and functionalized wall surface are contained, at least for the duration of an experiment. While, the system of FIG. 1 includes an acoustic force generator, other ways of applying a force on the cells may be used as well. For example, a system that uses a centrifugal force generator for applying a force on the cells is described in more detail with reference to FIG. 8. Since the system of FIG. 1 is configured to apply a force in a controlled manner, by means of the force generator, the system may also be referred to as a force spectroscopy system.

With the system depicted in FIG. 1, a force can be applied to one or more cellular bodies in the holding space for separating at least some of the one or more cellular bodies from the functionalized wall surface. Then, the imaging system can be used to capture a sequence of images from the one or more cellular bodies while said force is applied. Based on the obtained images, the interaction between the one or more cellular bodies and functionalized wall surface can be determined in accordance with any of the methods described herein.

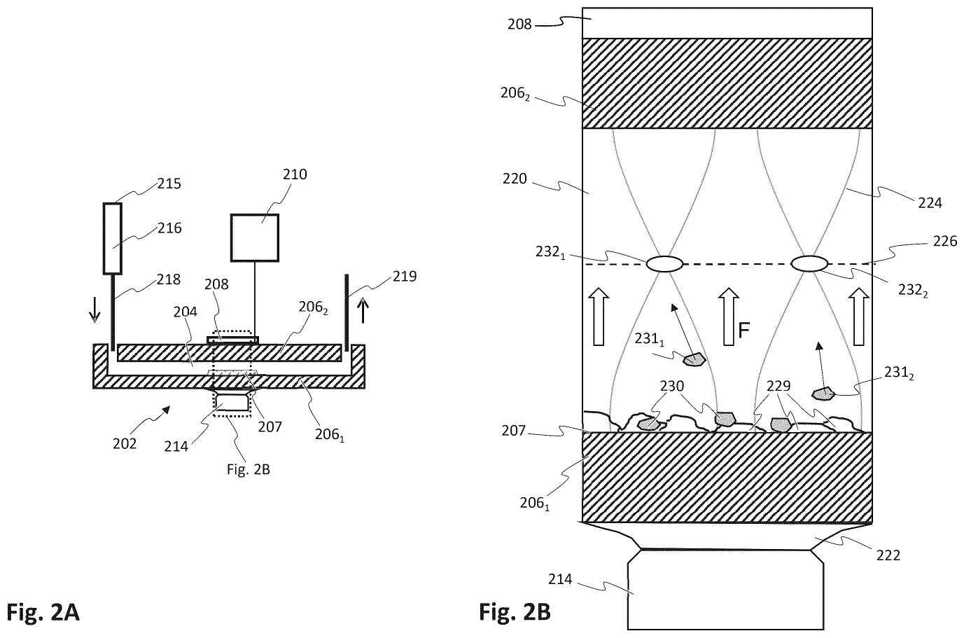

FIGS. 2A and 2B schematically depict cross-sectional views of a sample holder according to an embodiment. FIG. 2B illustrates a detail of the sample holder of FIG. 2A as indicated therein with “FIG. 2B”. In the depicted embodiment, the sample holder is a so-called flow cell. The sample holder 202 may comprise a first base part 2061 that has a recess being, at least locally, U-shaped in cross section and a cover part 2062 to cover and close (the recess in) the U-shaped part providing an enclosed holding space in cross section. The sample holder may comprise a functionalized wall surface 207 comprising first cellular bodies, e.g. cells.

Further, the sample holder 202 may be connected to a fluid flow system 215 for introducing fluid and unbound second cellular bodies, such as (other) cells, into the holding space of the sample holder and/or removing fluid from the holding space, e.g. for flowing fluid through the holding space (see arrows in FIG. 2A depicting the flow direction).

The fluid flow system may be comprised in or part of a manipulation and/or control system including one or more of reservoirs 216, pumps, valves, and conduits 218,219 for introducing and/or removing one or more fluids, sequentially and/or simultaneously. The sample holder and the fluid flow system may include connectors, which may be arranged on any suitable location on the sample holder, for coupling/decoupling. The sample holder may further include a force generator 208, e.g. an acoustic wave generator which may be implemented based on a (at least partially transparent) piezoelectric element connected to a controller 210. The sample holder may be imaged using an imaging system as described above with reference to FIG. 1, of which here only an objective 214 is shown.

FIG. 2B schematically depicts a cross-section of part of the sample holder 202 comprising, in the holding space, a sample comprising one or more biological cellular bodies 230,231_{1,2} in a fluid medium 220 as exemplary cellular bodies of interest. An imaging system including objective 214 is positioned underneath part of a sample holder (e.g., a chip) wherein the sample holder may comprise a capping layer 206₁, a matching layer 206₂, a fluid medium 220 contained in the holding space formed by the capping and the matching layer, and part of a force generator 208, e.g. a piezo element. An immersion liquid 222 between the objective and the capping layer may be used to improve the optical numerical aperture (NA) of the imaging system. Application of an AC voltage to the piezo element at an appropriate frequency will generate a resonant bulk acoustic standing wave 224 in the sample holder. The standing wave may have a nodal plane 226 in the fluid layer at a certain height above the functionalized wall 207 comprising first cellular bodies 229, attached to a wall surface of the sample holder. Second cellular bodies 230 are bound to the first cellular bodies. The standing wave may also have lateral nodes 232_{1,2}. Second cellular bodies that have a positive acoustic contrast factor with respect to the fluid medium will experience a force towards to the nodes.

One or more software programs that run on the data processing system of the system may be configured to control the camera, the force generator and the flow cell to conduct different experiments. In a typical experiment, first cellular bodies, e.g. target cells, are provided on the functionalized wall surface of the holding space of the flow cell. Second cellular bodies, e.g. effector cells, may be flushed into the holding space and may interact, e.g. bind, with the first cellular bodies. This interaction can be probed by analyzing the response of the second cellular bodies that are bound to the first cellular bodies as a function of the applied force. As shown in the figure, an acoustic force is applied perpendicularly to the functionalized wall surface comprising the first (and, at least initially, second) cellular bodies (indicated with upward open arrows). As a result, one or more second cellular bodies (e.g., effector cells) may detach from the first cellular bodies (e.g., target cells) and migrate to an acoustic node at a certain applied force (migration vectors for the cellular bodies are indicated with solid black arrows in FIG. 2B). This way, detachment events for different cellular bodies 231_{1,2} may occur wherein the detachment events are associated with different applied forces.

The force may be applied as a ramp force, i.e., a force that increases in time, preferably in a linear fashion. During application of the ramp force, the spatiotemporal response of the second cellular bodies is captured by an imaging system, e.g. as described above with reference to FIG. 1. By analyzing the video frames, also referred to as images, information about interaction between cellular bodies, e.g. effector and target cells, can be determined. To that end, the data processing system, also referred to as the computer, may include an image processing module 128 comprising one or more image processing algorithms for analyzing the response of the cells when they are manipulated in the flow cell using the force generator. The image analysis of the video frames is described hereunder in greater detail.

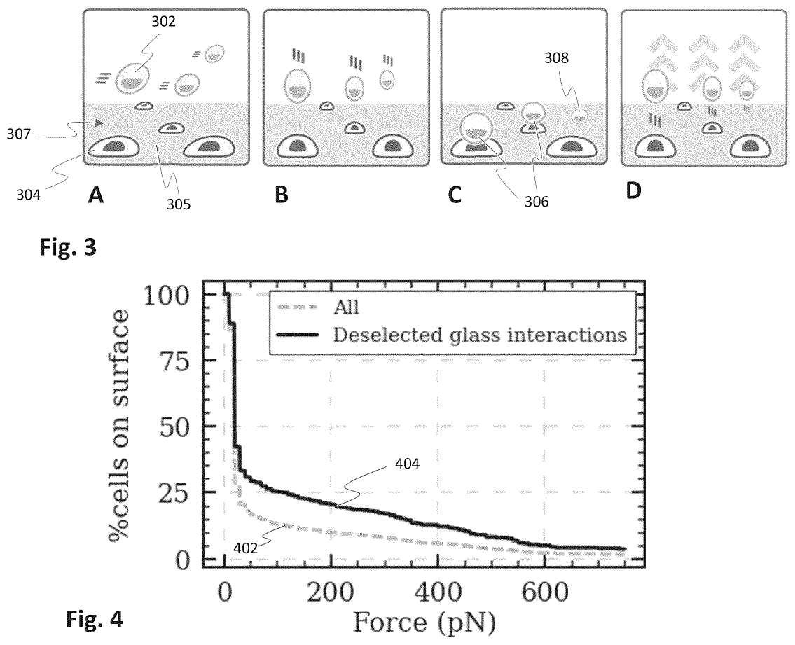

FIG. 3A-3D depict schematics of processes occurring in a holding space, e.g. of a microfluidic cell. The holding space comprises a functionalized wall surface comprising first cellular bodies, e.g., target cells. The holding space may be part of a force spectroscopy system, e.g., an acoustic force spectroscopy system as described above with reference to FIGS. 1 and 2 or a centrifugal force spectroscopy system as described below with reference to FIG. 8. The processes in the holding space may be imaged from below or from the top using an imaging system, e.g., as described with reference to FIG. 1.

As depicted in FIG. 3A, a process may start with flushing second cellular bodies 302, e.g., effector cells, into the holding space, comprising a functionalized wall surface 307. The functionalized wall surface may comprise the first cellular bodies 304, e.g., target cells. The functionalized wall surface may additionally comprise empty patches 305. The introduction of the second cellular bodies into the holding space may take a predetermined period of time, e.g. between 1 and 5 seconds. This introduction (flushing) is typically a relatively violent event, which may lead to displacement of the first cellular bodies on the functionalized wall surface.

After flushing, the second cellular bodies are allowed to settle onto the functionalized wall comprising the first cellular bodies (FIG. 3B). When the second cellular bodies reach the functionalized wall, the second cellular bodies may move around over the functionalized surface. Different types of second cellular bodies may move around more or less actively. The phase in which the second cellular bodies settle onto the functionalized wall may be referred to as the incubation phase. In a typical experiment, the incubation phase may take up to 1-15 minutes or longer.

During the incubation phase, the second cellular bodies may move around over the functionalized wall surface until they bind to a (suitable) first cellular body, thus forming a bound cell pair 306 (FIG. 3C), e.g., an effector cell-target cell pair. However, in many experiments, not all second bodies bind to a first cellular body. For example, some second cellular bodies 308 may instead end up on an empty patch of the functionalized wall surface. In some cases, some second cellular bodies may bind to the empty patch, e.g., to the priming layer or bare glass present on the empty patch; other second cellular bodies may fail to find a suitable first cellular body and remain unbound. During the incubation phase, the first cellular bodies may also move around, but typically much less than the second cellular bodies.

At the end of the incubation phase, the holding space may be imaged when the cells have been introduced into the holding space and settled on the functionalized wall, using first and second imaging modalities to obtain one or more first, respectively second images. In the first, respectively second images, a set or groups of pixels representing first and/or second cellular bodies in the captured images may be detected. After the incubation phase, a force may be applied to the second cellular bodies 306,308 that are present on the functionalized wall surface. The force is simultaneously applied both to second cellular bodies that are bound to first cellular bodies and to the second cellular bodies on empty patches. The force may have a direction away from the functionalized wall surface, e.g. substantially perpendicular to the functionalized wall surface. In some systems, such as shear-flow systems, the force may have a direction that is predominantly parallel to the functionalized wall surface.

When the force is sufficiently large, the second cellular bodies will move away from the functionalized wall surface in a direction that depends on the applied force, which may have an axial component perpendicular to the functionalized wall (e.g. the z-direction) and two lateral components in the plane of the functionalized wall (e.g. the x and y direction). When the second cellular body is no longer bound to the functionalized wall surface, this is known as a detachment event (FIG. 3D). The time at which an event occurs can be associated with a force that is exerted on the second cellular bodies. In a typical experiment, the force ramp may take between 2-10 minutes, but it can also be shorter or longer.

The goal of such a measurement is typically to determine a binding force between the first cellular bodies and the second cellular bodies. Therefore, it is desirable to be able to distinguish between second cellular bodies bound to, or at least in contact with, first cellular bodies, for example by a method as described in this disclosure. Depending on the experiment, the measurements for second cellular bodies on empty patches, i.e., second cellular bodies having no or insufficient interaction with first cellular bodies, may be discarded. This way, the accuracy of measurements of interactions between first and second cellular bodies may be increased.

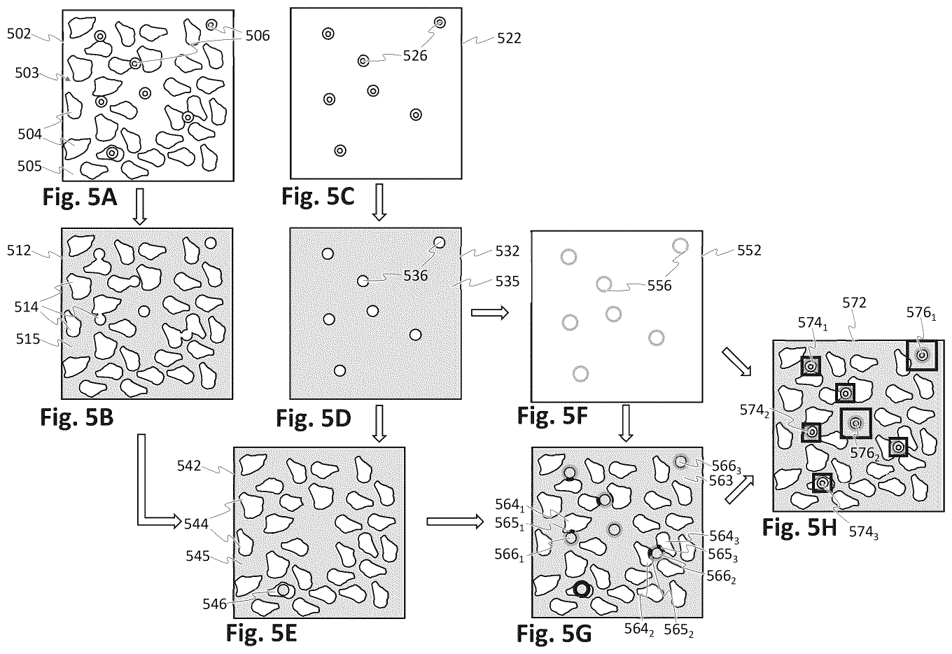

Based on a measurement scheme as described with reference to FIG. 3, various parameters of the first and/or second cellular bodies can be determined. For example, FIG. 4 depicts two cell avidity curves which may be determined by applying a force ramp to the second cellular bodies on the functionalized wall surface and determining the percentage of attached second cellular bodies as a function of the applied force. Based on the type of first cellular bodies provided on the functionalized wall surface, and based on the type of second cellular bodies possibly interacting with the first cellular bodies, the cellular bodies may exhibit, e.g., a low cell avidity curve (weak binding forces between first and second cellular bodies) or a high cell avidity curve (strong binding forces between first and second cellular bodies).

The first curve 402 depicted in FIG. 4 (dashed line) depicts the cell avidity as determined based on all second cellular bodies, i.e., without selection of only second cellular bodies that interact with first cellular bodies. The second curve 404 (solid line) depicts the cell avidity after selection of second cellular bodies that interact with first cellular bodies. As a result, the determined cell avidity is substantially higher than when also the second cellular bodies not interacting with the first cellular bodies were included in the analysis.

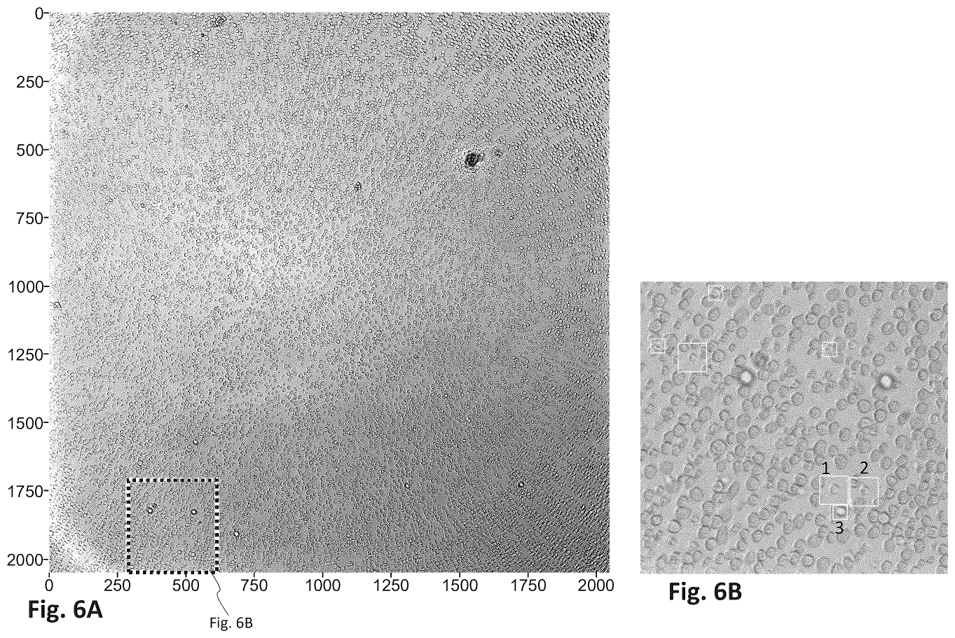

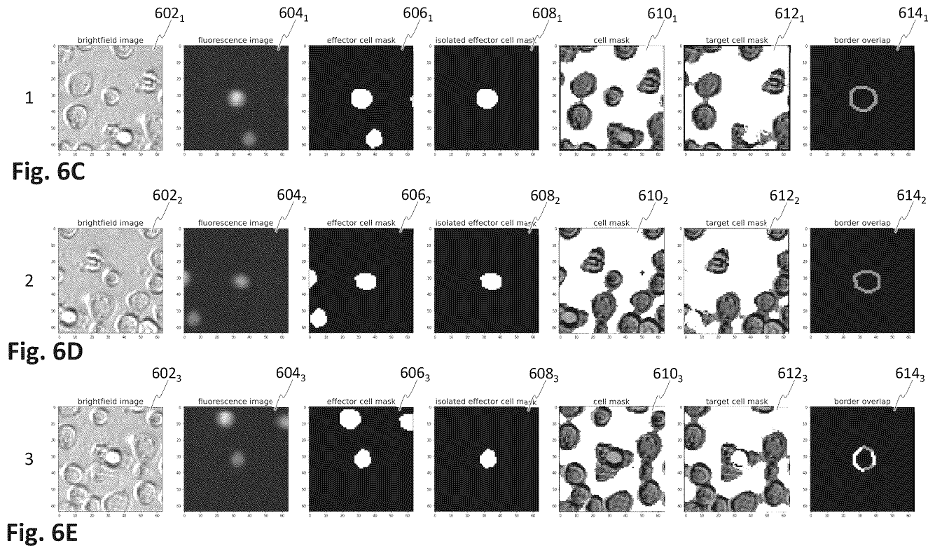

FIG. 5A-H schematically illustrate selection of first cellular bodies interacting with second cellular bodies in a holding space according to an embodiment. FIG. 5A depicts a first image 502 obtained using a first imaging modality, in this example bright-field imaging. The image represents a top view of a holding space, e.g., a microfluidic cell, including a functionalized wall 503 comprising first cellular bodies 504, e.g., target cells, and empty patches 505. In other embodiments, a bottom view may be used. This image may represent an exemplary situation during a force spectroscopy experiment, wherein second cellular bodies 506, e.g., effector cells, have been flushed into the holding space and allowed to settle. The second cellular bodies are visible in the image against a background representing the functionalized wall comprising the target cells. Although in this depicted example the first cellular bodies have a shape that is quite different from that of the second cellular bodies, cell shapes in actual experiments may be much more alike, as will be shown in more detail in FIG. 6A-E. Therefore, in a bright-field image, it can be difficult to distinguish the first cellular bodies form the second cellular bodies.

Based on bright-field image 502, a first cell mask 512 may be obtained as depicted in FIG. 5B. The first cell mask may comprise pixels representing a (first or second) cellular body 514 (shown in white) and pixels representing an empty patch 515 (shown in grey). The first cell mask can be a binary map with a pixel value 1 representing presence of a (first or second) cellular body and a pixel value 0 representing absence of a cellular body, for example. In a typical embodiment, the first cell mask does not distinguish between first and second cellular bodies. In some embodiments, a plurality of images may be used to determine the first cell mask, e.g., a so-called z-stack, i.e., a plurality of images having parallel focal planes at different distances from the functionalized wall surface.

Known image processing algorithms may be used to detect cellular bodies in the bright-field image. Such image processing algorithm may for example detect groups of pixels of a certain intensity and use classification rules that include e.g. size, geometry, contrast and changes in size, geometry and contrast, to determine if such group of pixels may be classified as a cellular body. For example, the first cell mask may be determined using one or more of the following classifiers: decision tree, random forest, support vector machine, Naïve Bayes, k-nearest neighbors, or an artificial neural network. The classifier may use one or more of the following features: Gaussian blurring, Gaussian gradient, structure tensor, Hessian eigenvalues, features using the intensity profile of each pixel along the vertical-direction, computational phase-contrast. Other methods may be apparent to the skilled person.

FIG. 5C depicts a second image 522 obtained using a second imaging modality, in this example fluorescence imaging. The image represents substantially the same view of the same holding space as the first image 502. In some embodiments, the same camera may be used to obtain both the first image and the second image, e.g. using an interlacing technique as described above with reference to FIG. 1. In other embodiments, different cameras may be used. In such embodiments, known image matching algorithms may be used to map the first image on the second image or vice versa. In some embodiments, a bottom view may be used. The second image is preferably obtained substantially simultaneous with the first image. In this context, substantially simultaneous means that the time interval between acquisition of the first image and the second image is short compared to the time scale at which the imaged scene changes, e.g., due to cell movement. In some embodiments, it may be sufficient that the images are obtained within one minute from each other, but in a typical embodiment, the images are acquired with less than a second time difference.

If fluorescence imaging is used to image the first and/or second cellular bodies, the first and/or second cellular bodies should comprise suitable fluorescent markers. Preferably, however, the first cellular bodies are not fluorescently labelled. If both the first and the second cellular bodies are fluorescently labelled, the first cellular bodies should be differently labelled than the second cellular bodies, i.e., emitting fluorescent light of a substantially different wavelength and/or being sensitive to excitation light of a substantially different wavelength.

Based on the second image 522, a second cell mask 532 representing the second cellular bodies may be obtained, as depicted in FIG. 5D. In a typical embodiment, the second cell mask may be obtained by thresholding the second image using a masking threshold. The masking threshold can be a global threshold or a local threshold, e.g. based on the average intensity in an area substantially larger than a typical first cellular body. The pixels representing second cellular bodies 536 are shown in white, whereas the pixels not representing second cellular bodies 535 are shown in grey. The second cell mask can be a binary map with a pixel value 1 representing presence of a second cellular body and a pixel value 0 representing absence of a second cellular body, for example.

Based on the first cell mask 512 and the second cell mask 532 a third cell mask 542 representing (only) first cellular bodies may be obtained, as depicted in FIG. 5E. In the depicted example, the third cell mask may be obtained by subtracting the second cell mask (representing the second cellular bodies) from the first cell mask (representing both first and second cellular bodies). This may result in (parts of) first cellular bodies being unmasked, as is most evident for first cellular body 546. However, that does not affect the method as described here, provided at least part of the first cellular body remains.

In some embodiments, the first cellular bodies may be fluorescently labelled while the second cellular bodies are not. In such an embodiment, a cell mask representing only first cellular bodies may be obtained by thresholding a fluorescence image and a cell mask representing only second cellular bodies may be obtained by subtracting the cell mask representing only first cellular bodies from a bright-field image. The resulting cell masks may be slightly different, but except for instances where a first cellular body and a second cellular body completely overlap, the resulting image filter will be practically the same.

In other embodiments, both the first cellular bodies and the second cellular bodies may be labelled, e.g., using labels with different fluorescent properties. In such an embodiment, the cell mask representing only first cellular bodies may be obtained by thresholding a first fluorescence image and the cell mask representing only second cellular bodies may be obtained by thresholding a second fluorescence image. In that case, there is no need to subtract masks from each other. While such an embodiment is computationally efficient, it may practically and/or biologically be more demanding.

In some embodiments, neither the first cellular bodies nor the second cellular bodies are labelled. In such an embodiment, there should be a different way to distinguish between the first and second cellular bodies, e.g., based on a shape, texture, or other visual property or based on e.g. a molecular signature that may be visualized without labelling (e.g. an autofluorescence signature or a Raman signature). If suitable first and second cellular bodies are selected, this distinction may be achieved using the same or similar methods as described above with reference to FIG. 5B. In that case, the first image and the second image may be the same (first) image, and the cell mask representing only second cellular bodies and the cell mask representing only first cellular bodies may be obtained directly from the same image, possibly a bright-field image. While such an embodiment has the advantage that no labelling is required, the selection of suitable first and second cellular bodies is limited, and the creation of proper cell masks is typically computationally harder than in cases based on labelled imaging, e.g., fluorescence imaging.

FIG. 5F depicts an image 552 representing border areas 556 of the second cellular bodies. Although, in this example, the border areas for all second cellular bodies are depicted in the same image, in some instances, a border area is determined separately for each second cellular body. By analyzing each second cellular body separately, overlap of borders of nearby second cellular bodies is prevented. In the depicted example, the border area is determined by growing the mask determined in the second cell mask 532 with a predetermined number of pixels, e.g., two pixels, and subsequently removing the second cell mask. This way, pixels may be selected that have not been identified as representing a second cellular body, but that are within a predetermined distance of a pixel that has been identified as representing a second cellular body. Other embodiments may use other methods to determine a border area. In some embodiments, the size of the border area may be determined interactively. In some embodiments, the size of the border area may depend on the type, size, and/or shape of the first and/or second cellular bodies.

Based on the cell mask 542 representing only the first cellular bodies and the determined border areas 552 of the second cellular bodies, for each second cellular body, an interaction parameter may be determined, as depicted in FIG. 5G. In the depicted example, the interaction parameter is based on an amount of overlap 565_{1_3} between the border area, marked in black, of a second cellular body 566_{1,2} and one or more first cellular bodies 566₁₋₃. For a second cellular body 566₃ that is located on an empty patch 563, there may be no overlap between the corresponding border and a first cellular body. The amount of overlap may be determined by determining the absolute or relative number of pixels that are both part of a border area and that have been determined to be representing a first cellular body. In some embodiments, the pixels may be weighted, with border pixels closer to a pixel representing a second cellular body (or in some cases, to a first cellular body) typically having a higher weight. In some embodiments, each contiguous overlap region should have a minimum size; in such embodiments, an overlap region with less than a threshold number of pixels may be given weight zero, for example.

Other embodiments may use different methods to determine an interaction parameter. For example, the interaction parameter may be based on matching of the local curvature. This metric is based on the assumption that if two cellular bodies are interacting, their boundaries should line up along the interaction area. Typically, the interaction parameter is an indication of a contact area between the second cellular body and one or more first cellular bodies.

In some embodiments, the one or more first image may constitute a first 3D image, and the one or more second images may constitute a second 3D image. In such an embodiment, the interaction parameter may be based on three-dimensional information. For example, a metric based on surface curvature rather than perimeter curvature may be used. In some cases, the area of the interaction surface may be determined more reliably in three dimensions than in two. However, the computational burden of a 2D analysis is typically much lower. In some case, the three-dimensional representation may be used to detect and/or identify the first and/or second cellular bodies, while determination of the interaction parameter is based on a two-dimensional representation. In some embodiments, the one or more first images comprise a plurality of images in order to facilitate detection of unlabelled cellular bodies, while the one or more second images comprises a single image allowing for straightforward detection of second cellular bodies.

Based on the interaction parameters determined for each second cellular body, the second cellular bodies may be divided into a plurality of categories. In the example depicted in FIG. 5H, an image filter 572 comprising only two categories of second cellular bodies: second cellular bodies for which the interaction parameter is larger than a predetermined threshold 574₁₋₃ (indicated with a small square) and second cellular bodies for which the interaction parameter is lower than the predetermined threshold 576_{1,2} (indicated with a large square).

In some embodiments, a region of interest may be determined for each second cellular body in a category. The image analysis to determine detachment events may then be limited to these regions of interest, reducing computation times. Moreover, because only second cellular bodies are selected that interact with, or at least are in contact with, first cellular bodies, the experimental results (e.g., an avidity curve) may be more reliable than when each second cellular body would be included in the analysis, as was shown above in FIG. 4.

In some embodiments, differently labelled second cellular bodies may be simultaneously present. In such an embodiment, a second image 522 may be obtained for each label type, and images 522-572 may be determined for each of the second images.

In some embodiments, additional filtering steps may be present, e.g., to remove second cellular bodies that are too close to each other to ensure proper processing.

FIG. 6A-6E illustrate measurements of effector cells interacting with target cells in a holding space according to an embodiment. FIG. 6A depicts an entire field of view (2048×2048 pixels) of a bright-field image of a holding space of a microfluidic cell comprising effector cells and target cells. The pixel size is approximately (1 μm)². The entire field of view comprises a few hundred effector cells and thousands of target cells. The image is obtained at the end of the incubation phase, as close to the onset of the initiation of the force ramp as possible, as explained above with reference to FIG. 3.

FIG. 6B depicts a close-up of a part of FIG. 6A, comprising 7 effector cells marked with a large or small square. FIG. 6C-6E depict a series of further close-ups (64×64 pixels each) of the areas around the effector cells labelled in FIG. 6B with numbers 1-3, respectively. For each of these series of images, the first image 602₁₋₃ depicts the bright-field image showing both effector cells and target cells. The second image 604₁₋₃ in the series depicts a fluorescence image of the same area, showing only the fluorescently labelled effector cells. The third image 606₁₋₃ in the series depicts effector cells masks, obtained by thresholding the fluorescence image. The fifth image 610₁₋₃ in the series depicts a cell mask obtained from the bright-field image, in this example using a random forest classifier, in which the empty patches are masked, and the effector cells and target cells are not masked. The sixth image 612₁₋₃ in the series depicts a target cell mask in which only the target cells are unmasked, obtained based on the cell mask and the effector cell mask.

In order to determine the interaction parameter, each effector cell is analyzed individually. Therefore, the fourth image 608₁₋₃ in the series depicts an isolated effector cell mask for a region of interest around the effector cell and centered on the effector cell. Other effector cells that might be (partly) present in the region of interest, are masked so that the isolated effector cell mask comprises only a single effector cell. In cases where two or more effector cells cannot be separated, both cells may be discarded for the final analysis.

The seventh image 614₁₋₃ in the series depicts a border area around each isolated effector cell mask. Based on the border area and the target cell mask, an amount of overlap has been determined for each of the effector cells. Here, grey indicates a part of the border region for which there is no overlap with a target cell, and white indicates a part of the border region for which there is overlap with a target cell. The first effector cell depicted in FIG. 6C and the second effector cell depicted in FIG. 6D have no overlap with a target cell, while the third effector cell depicted in FIG. 6E has substantial overlap with, in this case, two target cells.

In some embodiments, further image processing steps may be present. For instance, in the current example, effector cells that had remained from a previous experiment were marked and discarded. Additionally, effector cells that were too close together (e.g., touching each other) were discarded. After such pre-processing steps, circa 250 effector cells available for analysis remained in FIG. 6A. For each of these, the steps as depicted in FIG. 6C-E were performed. Out of these circa 250 effector cells, about 40 have been marked as having no or insufficient interaction with a target cell. Thus, these marked effector cells may be removed from an analysis for determining interaction between the effector cells and the target cells.

The number of effector cells (or more in general, second cellular bodies) that have no or insufficient interaction with a target cell (or more in general, first cellular body) depends on the confluence of the target cell layer. In samples with a 100% confluent layer (full coverage of the functionalized wall surface) there would, in principle, be no effector cells that are excluded because of an interaction parameter that does not meet the interaction threshold. By contrast, in a sample with only 50% monolayer confluence roughly 50% of the effector cells may be expected to land on an empty patch (area not covered with a target cell). If the effector cells are not highly active and searching in the incubation phase (such that they remain mostly where they land) this would lead to exclusion of about 50% of the effector cells. In a typical experiment, between tens to a few hundred second cellular bodies may be marked as having no or insufficient interaction with a first cellular body on the functionalized wall surface.

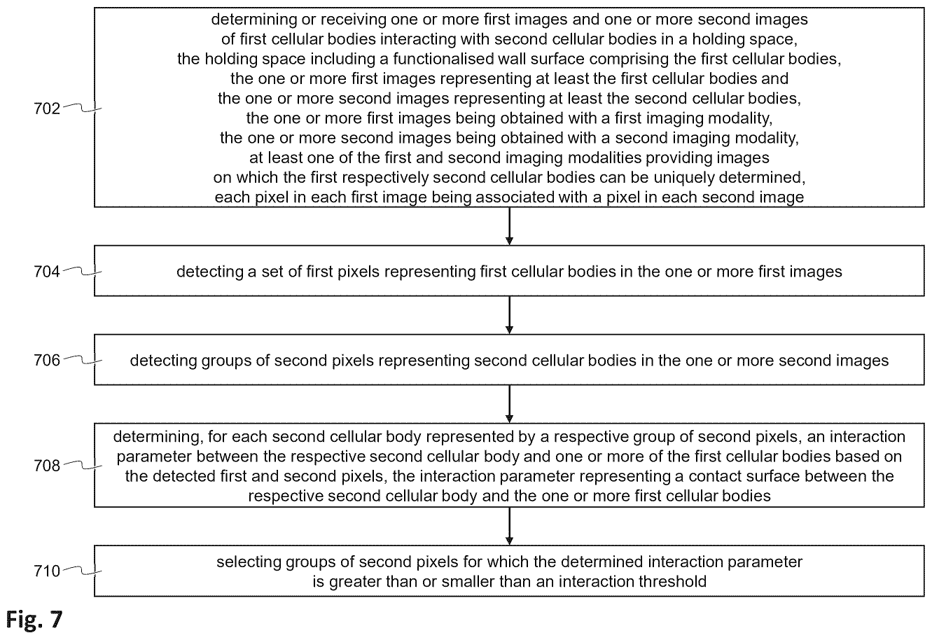

FIG. 7 depicts a flow diagram of a method of determining an interaction between first and second cellular bodies according to an embodiment. In a first step 702, the method may comprise determining or receiving one or more first images and one or more second images. The one or more first images and the one or more second images may be images of first cellular bodies interacting with second cellular bodies in a holding space. The holding space may include a functionalized wall surface comprising the first cellular bodies. The one or more first images may at least represent the first cellular bodies. The one or more first images may be acquired using a suitable first imaging modality, for example an imaging modality that provides sufficient contrast and that does not require extensive sample preparation. The first imaging modality may further be selected based on e.g. practical and/or economic considerations. In a typical embodiment, bright-field imaging is used to acquire the one or more first images; in that case, the one or more first images typically depict both the first cellular bodies and the second cellular bodies. The one or more second images may represent at least the second cellular bodies. For example, the second cellular bodies may be labelled, e.g., fluorescently labelled, and the one or more second images may be acquired using a suitable second imaging modality, e.g. fluorescence imaging. At least one of the first and second imaging modalities may provide images on which the first respectively second cellular bodies can be uniquely determined, i.e., on which the first respectively second cellular bodies can be distinguished from each other and from a potentially present background. The background can comprise, e.g., empty patches of the functionalized wall surface. Each pixel in a first image may be associated with a pixel in the one or more second images.

In a step 704, the method may further comprise detecting a set of first pixels representing first cellular bodies in the one or more first images. The detection may use known image processing techniques, for instance as described above with reference to FIG. 5B, in particular when the one or more first images are acquired using bright-field imaging. In some embodiments, the one or more first images may comprise pixels representing first cellular bodies and pixels representing second cellular bodies. In such an embodiment, the pixels representing first cellular bodies may, for example, be identified making use of the groups of second pixels detected in step 706.

In a step 706, the method may further comprise detecting groups of second pixels representing second cellular bodies. The detection may comprise, for example, thresholding the image. Thresholding can be an effective way of detecting second cellular bodies in fluorescence images, for example. In other embodiments, more advanced image processing methods may be used to detect the groups of first pixels.

Optionally, empty patches may be detected by determining pixels that are not (associated with pixels) in the set of first pixels nor in the groups of second pixels; thus, the empty patches may be separated from the parts of the functionalized wall surface comprising cellular bodies.

In a step 708, the method may further comprise determining, for each second cellular body, an interaction parameter between the respective second cellular body and one or more of the first cellular bodies. The interaction parameter may be based on the detected first and second pixels. The interaction parameter may represent a contact surface between the respective second cellular body and the one or more first cellular bodies.

In a step 710, the method may further comprise selecting groups of second pixels for which the determined interaction parameter is greater than or smaller than an interaction threshold. This way, only second cellular bodies having sufficient interaction with first cellular bodies may be selected.

FIG. 8 schematically depicts a further force spectroscopy system configured to capture images of a force spectroscopy experiment. This system includes a rotary arm 830 that is rotatable mounted onto a rotor system that includes a rotor 832 and a rotary joint 834. A holding space 804, e.g. a microfluidic cell, comprising first and second cellular bodies (e.g. effector cells, and target cells attached to a functionalized wall of the holding space) may be mounted onto the rotary arm. Further, a light source 820, an adjustable objective 814, a tube lens 826 and a camera 816 may form an imaging system for capturing images of first cellular bodies interacting with second cellular bodies. A rotor controller 810 may be used to control the rotor system to spin the rotary arm in a circular motion so that a centrifugal force is exerted onto the first cellular bodies. The system may be connected to a data processing system 818 that includes a processing module 828 that is configured to control the rotor controller and the imaging system. Further, when in use, the data processing system may receive captured images 836 of the holding space while a force ramp is exerted onto effector cells. Further, the processing module is configured to process the captures images in a similar way as described with reference to FIG. 3-7 above. Batteries may be incorporated in or on the rotary arm in order to power any of the elements used for the imaging system (e.g. light source, camera, objective adjustment mechanism, etc.). Electrical power and/or signals may also be provided through a slip-ring mechanism in the rotary joint. Optical signals may also be used for communication between the data processing system and the imaging system (e.g. the camera) e.g. through a rotary fiber joint. Alternatively wireless communication (e.g. using radio signals) may be used for communication between the data processing system and the imaging system. Also, the imaging system may operate fully independently without communication between the data processing system and the imaging system while the rotary system is in use. In that case the imaging system may include a g-force sensor in order to correlate images to a force applied to the sample and data may be stored onto a memory system while the system is in use and the rotary arm is spinning. Exemplary embodiments of such force spectroscopy systems are described in WO2017/147398 and U.S. Pat. No. 8,795,143 which are hereby incorporated by reference into this application.

FIG. 9 is a block diagram illustrating exemplary data processing systems described in this disclosure. Data processing system 900 may include at least one processor 902 coupled to memory elements 904 through a system bus 906. As such, the data processing system may store program code within memory elements 904. Further, processor 902 may execute the program code accessed from memory elements 904 via system bus 906. In one aspect, data processing system may be implemented as a computer that is suitable for storing and/or executing program code. It should be appreciated, however, that data processing system 900 may be implemented in the form of any system including a processor and memory that is capable of performing the functions described within this specification.

Memory elements 904 may include one or more physical memory devices such as, for example, local memory 908 and one or more bulk storage devices 910. Local memory may refer to random access memory or other non-persistent memory device(s) generally used during actual execution of the program code. A bulk storage device may be implemented as a hard drive or other persistent data storage device. The processing system 900 may also include one or more cache memories (not shown) that provide temporary storage of at least some program code in order to reduce the number of times program code must be retrieved from bulk storage device 910 during execution.

Input/output (I/O) devices depicted as input device 912 and output device 914 optionally can be coupled to the data processing system. Examples of input device may include, but are not limited to, for example, a keyboard, a pointing device such as a mouse, or the like. Examples of output device may include, but are not limited to, for example, a monitor or display, speakers, or the like. Input device and/or output device may be coupled to data processing system either directly or through intervening I/O controllers. A network adapter 916 may also be coupled to data processing system to enable it to become coupled to other systems, computer systems, remote network devices, and/or remote storage devices through intervening private or public networks. The network adapter may comprise a data receiver for receiving data that is transmitted by said systems, devices and/or networks to said data and a data transmitter for transmitting data to said systems, devices and/or networks. Modems, cable modems, and Ethernet cards are examples of different types of network adapter that may be used with data processing system 900.

As pictured in FIG. 9, memory elements 904 may store an application 918. It should be appreciated that data processing system 900 may further execute an operating system (not shown) that can facilitate execution of the application. Application, being implemented in the form of executable program code, can be executed by data processing system 900, e.g., by processor 902. Responsive to executing application, data processing system may be configured to perform one or more operations to be described herein in further detail.

In one aspect, for example, data processing system 900 may represent a client data processing system. In that case, application 918 may represent a client application that, when executed, configures data processing system 900 to perform the various functions described herein with reference to a “client”. Examples of a client can include, but are not limited to, a personal computer, a portable computer, a mobile phone, or the like.

In another aspect, data processing system may represent a server. For example, data processing system may represent an (HTTP) server in which case application 918, when executed, may configure data processing system to perform (HTTP) server operations. In another aspect, data processing system may represent a module, unit or function as referred to in this specification.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for selecting cells, the method comprising:
determining or receiving one or more first images and one or more second images of first cellular bodies interacting with second cellular bodies in a holding space, the holding space including a functionalized wall surface comprising the first cellular bodies, the one or more first images representing at least the first cellular bodies and the one or more second images representing at least the second cellular bodies, the one or more first images being obtained with a first imaging modality, the one or more second images being obtained with a second imaging modality, at least one of the first and second imaging modalities providing images on which the first respectively second cellular bodies can be uniquely determined, each pixel in each of the one or more first images being associated with a pixel in each of the one or more second images;
detecting a set of first pixels representing first cellular bodies in the one or more first images;
detecting groups of second pixels representing second cellular bodies in the one or more second images;
determining, for each second cellular body represented by a respective group of second pixels, an interaction parameter between the respective second cellular body and one or more of the first cellular bodies based on the detected first and second pixels, the interaction parameter representing a contact surface between the respective second cellular body and the one or more first cellular bodies; and
selecting groups of second pixels for which the determined interaction parameter is greater than or smaller than an interaction threshold.

2. The method as claimed in claim 1, wherein detecting the set of first pixels representing first cellular bodies comprises detecting first pixels in the one or more first images representing either first cellular bodies or second cellular bodies, and selecting, from the detected first pixels, the set of first pixels representing first cellular bodies; or,
wherein detecting the groups of second pixels representing second cellular bodies comprises detecting second pixels in the one or more second images representing either first cellular bodies or second cellular bodies, and selecting, from the detected second pixels, the groups of second pixels representing second cellular bodies.

3. The method as claimed in claim 1, wherein determining an interaction parameter for a group of second pixels comprises:
determining a border region for the group of second pixels and determining an absolute and/or relative amount of pixels in the border region that are associated with pixels in the set of first pixels.

4. The method as claimed in claim 3, wherein determining a border region of a group of second pixels comprises selecting pixels not belonging to the group of second pixels that have a distance to a pixel in the group of second pixels that is equal to or less than a predetermined or interactively determined amount.

5. The method as claimed in claim 3, wherein determining an interaction parameter for a group of second pixels comprises:
assigning a weight to pixels in the border region, the weight being based on a distance between the pixel and a nearest pixel in the group of second pixels.

6. The method as claimed in claim 1, wherein determining an interaction parameter for a group of second pixels comprises:
comparing a local curvature of the group of second pixels with the local curvature of the set of first pixels.

7. The method as claimed in claim 1, further comprising:
determining an image filter based on the selected groups of second pixels.

8. The method as claimed in claim 1, wherein the interaction threshold is a predetermined threshold or wherein the interaction threshold is determined interactively based on input received from a user.

9. The method as claimed in claim 1, wherein the interaction threshold depends on a type, size and/or shape of first cellular bodies and/or of the second cellular bodies.

10. The method as claimed in claim 1, further comprising:
determining a detachment event, a detachment event defining a second cellular body being detached from a first cellular body due to application of a force on the second cellular body.

11. The method as claimed in claim 10, further comprising:
determining information about the interaction between the first cellular body and the second cellular body based on the force applied to the second cellular body at a moment of the detachment event.

12. A data processing-system comprising
a computer readable storage medium having computer readable program code embodied therewith, and
a processor coupled to the computer readable storage medium, wherein responsive to executing the computer readable program code, the processor is configured to:
determine or receive one or more first images and one or more second images of first cellular bodies interacting with second cellular bodies in a holding space, the holding space including a functionalized wall surface comprising the first cellular bodies, the one or more first images representing at least the first cellular bodies and the one or more second images representing at least the second cellular bodies, the one or more first images being obtained with a first imaging modality, the one or more second images being obtained with a second imaging modality, at least one of the first and second imaging modalities providing images on which the first respectively second cellular bodies can be uniquely determined, each pixel in each of the one or more first images being associated with a pixel in each of the one or more second images;
detect a set of first pixels representing first cellular bodies in the one or more first images;
detect groups of second pixels representing second cellular bodies in the one or more second images;
determine, for each second cellular body represented by a respective group of second pixels, an interaction parameter between the respective second cellular body and one or more of the first cellular bodies based on the detected first and second pixels, the interaction parameter representing a contact surface between the respective second cellular body and the one or more first cellular bodies; and
select groups of second pixels for which the determined interaction parameter is greater than or smaller than an interaction threshold.

13. (canceled)

14. The system as claimed in claim 12, further comprising:
a sample holder comprising the holding space, the holding space being configured to hold a fluid medium, the fluid medium comprising the one or more second cellular bodies;
a force generator configured to provide a force to the one or more second cellular bodies in the holding space; and
an imaging system configured to capture the one or more first images of the one or more first cellular bodies using the first imaging modality and configured to capture the one or more second images of the one or more second cellular bodies using the second imaging modality.

15. The system as claimed in claim 12, wherein detecting the set of first pixels representing first cellular bodies comprises detecting first pixels in the one or more first images representing either first cellular bodies or second cellular bodies, and selecting, from the detected first pixels, the set of first pixels representing first cellular bodies; or,
wherein detecting the groups of second pixels representing second cellular bodies comprises detecting second pixels in the one or more second images representing either first cellular bodies or second cellular bodies, and selecting, from the detected second pixels, the groups of second pixels representing second cellular bodies.

16. The system as claimed in claim 12, wherein determining an interaction parameter for a group of second pixels comprises:
determining a border region for the group of second pixels and determining an absolute and/or relative amount of pixels in the border region that are associated with pixels in the set of first pixels.

17. The system as claimed in claim 12, wherein determining an interaction parameter for a group of second pixels comprises:
comparing a local curvature of the group of second pixels with the local curvature of the set of first pixels.

18. A non-transitory computer-readable storage medium having computer-readable program code embodied therewith, the computer-readable program code, when executed or processed by a computer, being configured to:
determine or receive one or more first images and one or more second images of first cellular bodies interacting with second cellular bodies in a holding space, the holding space including a functionalized wall surface comprising the first cellular bodies, the one or more first images representing at least the first cellular bodies and the one or more second images representing at least the second cellular bodies, the one or more first images being obtained with a first imaging modality, the one or more second images being obtained with a second imaging modality, at least one of the first and second imaging modalities providing images on which the first respectively second cellular bodies can be uniquely determined, each pixel in each of the one or more first images being associated with a pixel in each of the one or more second images;
detect a set of first pixels representing first cellular bodies in the one or more first images;
detect groups of second pixels representing second cellular bodies in the one or more second images;
determine, for each second cellular body represented by a respective group of second pixels, an interaction parameter between the respective second cellular body and one or more of the first cellular bodies based on the detected first and second pixels, the interaction parameter representing a contact surface between the respective second cellular body and the one or more first cellular bodies; and
select groups of second pixels for which the determined interaction parameter is greater than or smaller than an interaction threshold.

19. The non-transitory computer-readable storage medium as claimed in claim 18, wherein detecting the set of first pixels representing first cellular bodies comprises detecting first pixels in the one or more first images representing either first cellular bodies or second cellular bodies, and selecting, from the detected first pixels, the set of first pixels representing first cellular bodies; or,
wherein detecting the groups of second pixels representing second cellular bodies comprises detecting second pixels in the one or more second images representing either first cellular bodies or second cellular bodies, and selecting, from the detected second pixels, the groups of second pixels representing second cellular bodies.

20. The non-transitory computer-readable storage medium as claimed in claim 18, wherein determining an interaction parameter for a group of second pixels comprises:
determining a border region for the group of second pixels and determining an absolute and/or relative amount of pixels in the border region that are associated with pixels in the set of first pixels.

21. The non-transitory computer-readable storage medium as claimed in claim 18, wherein determining an interaction parameter for a group of second pixels comprises:
comparing a local curvature of the group of second pixels with the local curvature of the set of first pixels.
